(19) United States
(12) Patent Application Publication
(10) Pub. No.: US 2013/0187845 A1
(43) Pub. Date: Jul. 25, 2013

(54) ADAPTIVE INTERFACE SYSTEM

(71) Applicants: Dinu Petre Madau, Canton, MI (US); Matthew Mark Mikolajczak, Novi, MI (US); Paul Morris, Ann Arbor, MI (US)

(72) Inventors: Dinu Petre Madau, Canton, MI (US); Matthew Mark Mikolajczak, Novi, MI (US); Paul Morris, Ann Arbor, MI (US)

(73) Assignee: VISTEON GLOBAL TECHNOLOGIES, INC., Van Buren Twp., MI (US)

(21) Appl. No.: 13/354,951

(22) Filed: Jan. 20, 2012

(51) Int. Cl. G09G 5/00

(52) U.S. Cl. 345/156

(57) ABSTRACT

An adaptive display system includes a user interface having a display for generating a visual output to a user, a sensor for capturing an image of a tracking region of the user and generating a sensor signal representing the captured image, and a processor in communication with the sensor and the display, wherein the processor receives the sensor signal, analyzes the sensor signal based upon an instruction set to determine a displacement of the tracking region of the user, and controls a visual indicator presented on the display based upon the displacement of the tracking region of the user.

### FIELD OF THE INVENTION

The present invention relates generally to a human-machine interface. In particular, the invention is directed to an adaptive interface system and a method for interacting with a user interface based on an adaptive tracking of a user.

### BACKGROUND OF THE INVENTION

Current vehicle systems have user interfaces that include one or more of the following components: a display, a touch screen, a touch sensor, a control knob, a user-engageable button, and other controllers. Typically, a user actuates a control by direct contact or physical manipulation. Most recently, vehicles also use eye-tracking to enable hands-free control of the vehicle systems such as a climate control system, an entertainment control system, a navigation system, and the like, for example. However, a detection of a position and a movement of an eye of an occupant of the vehicle can be hindered, or even prevented, in certain circumstances such as occlusion by an object or substance (e.g. a hand of the occupant, eye glasses, sunglasses, a hat, makeup, etc.), a relatively small eye size or lid opening of the occupant, vibrations of the vehicle, and the like, for example.

Typically, the eye-tracking devices and systems employ multiple high-resolution imagers and narrow-band infrared illuminators provided with filters to create and detect glints on the eye of the occupant. Complex mathematics and sophisticated computing are required to analyze the glints on the eye to determine a gaze direction of the occupant. As such, the eye-tracking devices and systems which can accurately determine the gaze direction of the occupant are limited, as well as expensive.

It would be desirable to develop an adaptive interface system which controls a visual indicator of a user interface based upon an adaptive tracking of a user.

### SUMMARY OF THE INVENTION

In concordance and agreement with the present invention, an adaptive interface system which controls a visual indicator of a user interface based upon an adaptive tracking of a user, has surprisingly been discovered.

In one embodiment, an adaptive interface system comprises: a user interface for controlling a vehicle system; a sensor for detecting a tracking region of a user and generating a sensor signal representing the tracking region of the user; and a processor in communication with the sensor and the user interface, wherein the processor receives the sensor signal, analyzes the sensor signal based upon an instruction set to determine a displacement of the tracking region, and controls a visual indicator presented on the user interface based upon the displacement of the tracking region.

In another embodiment, an adaptive interface system for a vehicle comprises: at least one user interface including a display, the display having a control for a vehicle system; a sensor for detecting a tracking region of a user by capturing an image of the tracking region of the user, wherein the sensor generates a sensor signal representing the captured image of the tracking region of the user; and a processor in communication with the sensor, the vehicle system, and the one user interface, wherein the processor receives the sensor signal, analyzes the sensor signal based upon an instruction set to determine a displacement of the tracking region of the user, and controls a visual indicator presented on the display based upon the displacement of the tracking region, and wherein the visual indicator selects the control for the vehicle system.

In yet another embodiment, the present invention is directed to a method for configuring a display.

The method comprises the steps of: providing a user interface for controlling a vehicle system; providing a sensor to detect a tracking region of a user; determining a displacement of the tracking region of the user; and controlling a visual indicator presented on the user interface based upon the displacement of the tracking region of the user.

The interface system of the present invention provides touchless control of at least one vehicle system at a relatively lower cost with fewer and less sophisticated components (i.e. a processor with less processing capacity, a smaller imager, a weaker illuminator, an elimination of filters, etc.) than current touchless systems (i.e. eye-tracking interface systems). Illumination requirements of the interface system are typically less than the current touchless systems since the interface system does not require creation and detection of glints on the eye of the occupant for operation. Accordingly, the interface system can employ an illuminator which provides relatively less illumination than the illuminators of the current touchless systems. The interface system also eliminates biometric concerns, as well as minimizes problems such as occlusion by an object or substance associated with the eye-tracking interface systems.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a fragmentary schematic perspective view of a vehicle including an adaptive interface system according to an embodiment of the present invention;

FIG. 2 is a schematic block diagram of the interface system of FIG. 1, the interface system including a plurality of user interfaces;

FIG. 3 is a fragmentary schematic top plan view of the vehicle including the interface system of FIGS. 1-2 showing a pointing vector of a driver of the vehicle directed towards a heads-up display of the vehicle;

FIG. 4 is a fragmentary schematic top plan view of the vehicle including the interface system of FIGS. 1-3 showing a pointing vector of a driver of the vehicle directed towards a center stack display of the vehicle; and

FIG. 5 is a fragmentary schematic top plan view of the vehicle including the interface system of FIGS. 1-4 showing a pointing vector of a passenger of the vehicle directed towards the center stack display of the vehicle.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

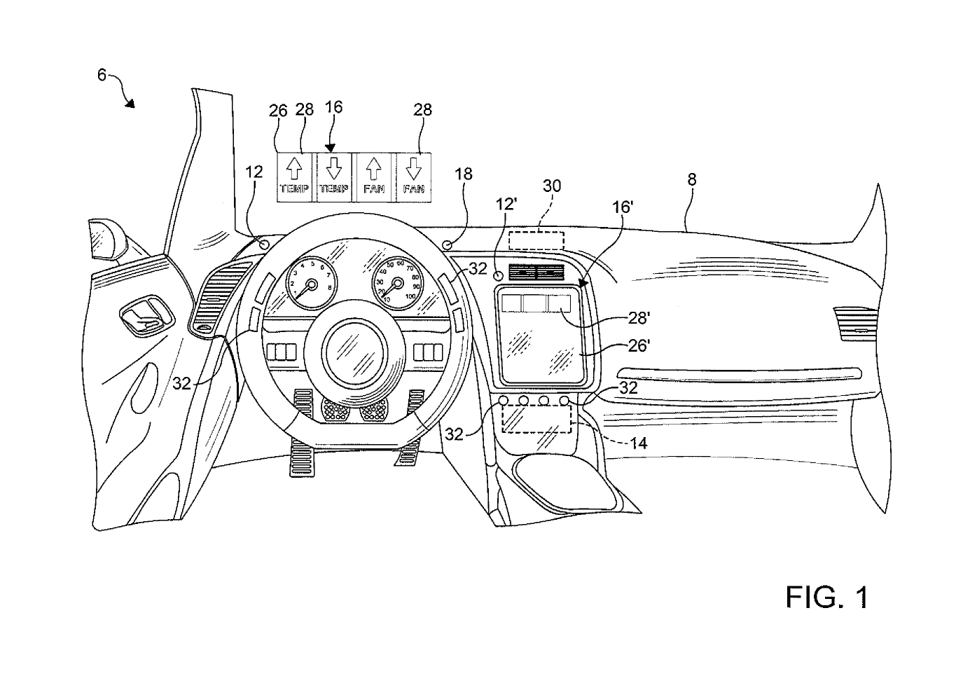

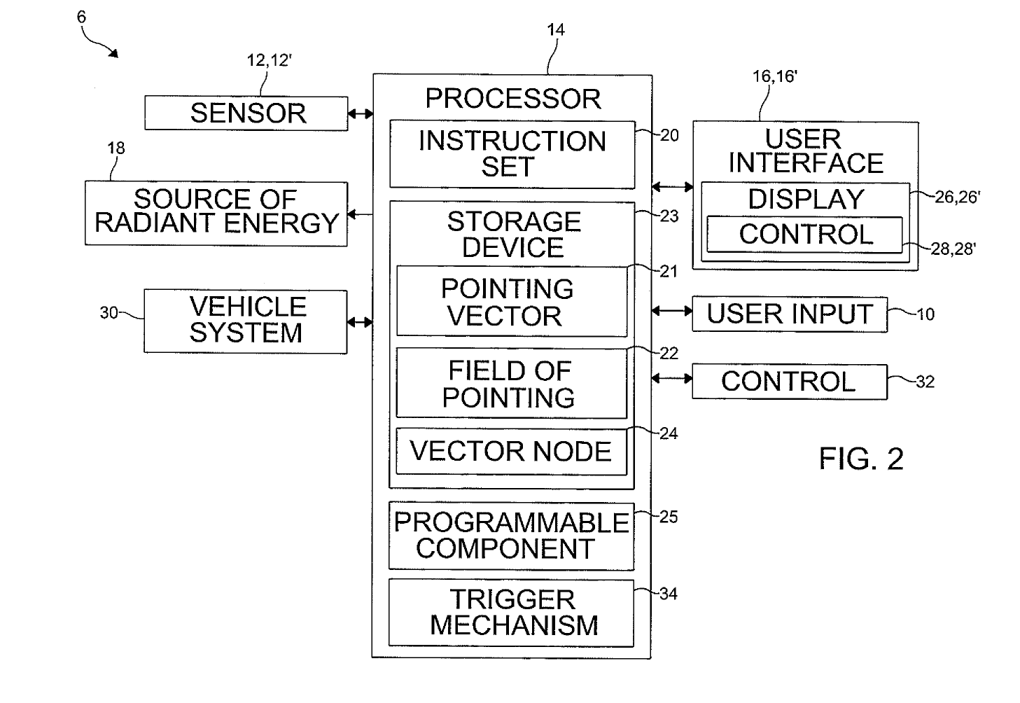

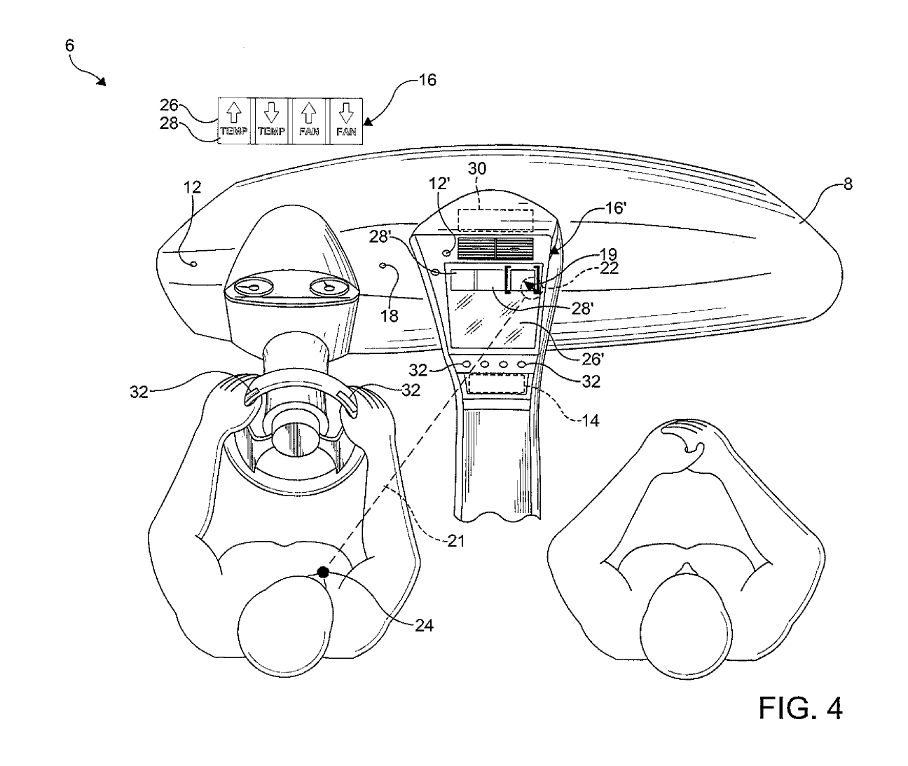

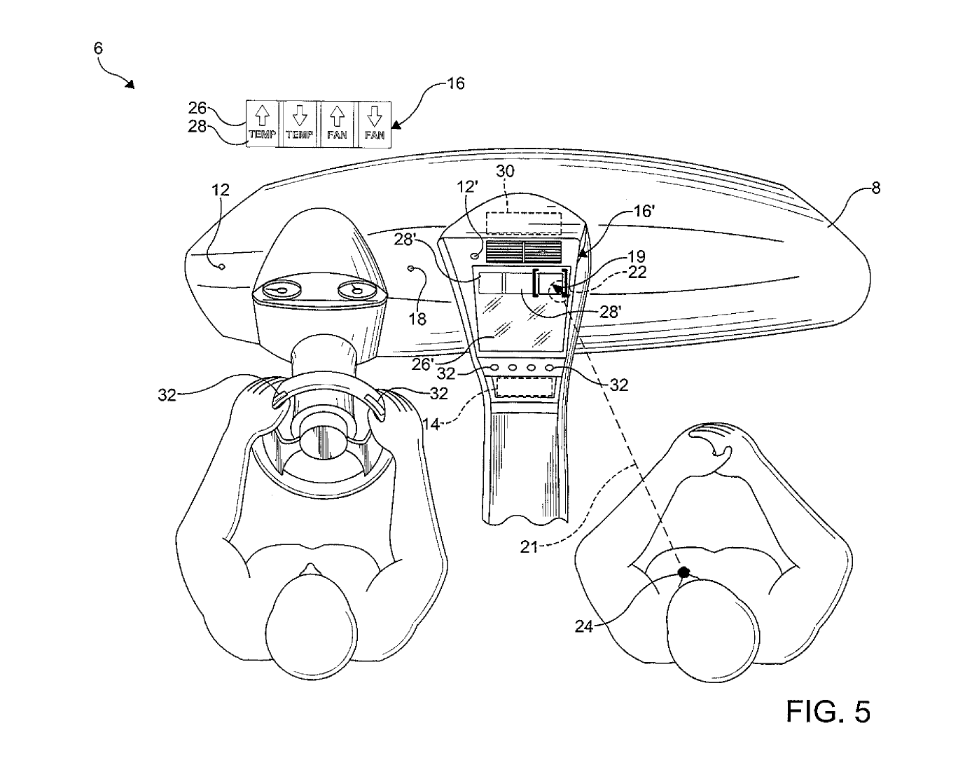

FIGS. 1-5 illustrate an adaptive interface system 6 for a vehicle 8 according to an embodiment of the present invention. In certain embodiments, the interface system 6 is activated and deactivated by a user input 10 (shown in FIG. 2). It is understood that the user-input 10 can be any user input such as a spatial command (e.g. an eye, a head, or a hand movement), an audible command (e.g. voice instruction), and a haptic command (e.g. a push button, a switch, a slide, etc.), for example. The interface system 6 includes a first sensor 12, a processor 14, and a first user interface 16 provided with a display 26. It is understood that the interface system can include additional sensors and user interfaces as desired. For example, the interface system 6 shown further includes a second sensor 12′ and a second user interface 16′ provided with a display 26′. The interface system 6 can include any number of components, as desired. The interface system 6 can be integrated in any user environment.

Each of the sensors 12, 12′ is a tracking device capable of detecting a tracking region of a user (e.g. a driver or a passenger of the vehicle 8). In certain embodiments, the tracking region can be at least a portion of a head, or an object associated with the head, of the user such as a face, a nose, a mouth, a chin, an eye or pair of eyes, an eyebrow or pair of eyebrows, an ear or pair of ears, eyeglasses or sunglasses, a hat, a headband, and any combination thereof, for example. In other certain embodiments, the tracking region can be at least a portion of the head, or an object associated with the head, of the user which provides maximum contrast or demarcation, for example.

The sensors 12, 12′ can be relatively low cost tracking devices which utilize relatively simple algorithms for detecting the tracking region. In certain embodiments, each of the sensors 12, 12′ is a camera for capturing a plurality of time-sequenced images of the tracking region and generating a sensor signal representing the captured images. As a non-limiting example, each of the sensors 12, 12′ is a complementary metal-oxide-semiconductor (CMOS) camera for capturing the time-sequenced images of the tracking region and generating a sensor signal representing the captured images.

In certain embodiments, each of the captured images is produced from a predetermined region of pixels which can be used for directional indication. For example, the predetermined region of pixels can be associated with the tracking region (e.g. at least the portion of the head, or an object associated with the head, of the user; at least the portion of the head, or an object associated with the head, of the user which provides maximum contrast or demarcation) or a virtual point formed by the tracking region. It is understood that any suitable camera and image capturing device can be used such as an active-pixel digital image camera, an optical image camera, or a thermal image camera, for example. It is further understood that other sensors (i.e. independent or paired with a camera sensor) can be used such as an infrared sensor, for example.

The sensors 12, 12′ shown are mounted in a dash or a center stack of the vehicle 8 with an unobstructed view of where the user is expected to be located during normal vehicle operation. Other locations for mounting the sensors 12, 12′ can be employed provided the sensors 12, 12′ are capable of focusing upon the tracking region of the user. For example, the sensors 12, 12′ may be mounted in a steering assembly or an instrument cluster.

In certain embodiments, at least one source of radiant energy 18 is disposed to illuminate the tracking region of the user. As a non-limiting example, the source of radiant energy 18 may be an infrared light emitting diode. However, other sources of the radiant energy can be used.

The processor 14 may be any device or system adapted to receive an input signal (e.g. the sensor signal), analyze the input signal, configure the user interfaces 16, 16′, and control a visual indicator 19 in response to the analysis of the input signal. The visual indicator 19 can be any visual indicator 19 as desired such as a cursor, a highlight, or a change in at least one of a color, a position, and a size of an object of the user interfaces 16, 16′, for example. In certain embodiments, the processor 14 is a micro-computer. In the embodiment shown, the processor 14 receives the input signal from at least one of the sensors 12, 12′.

As shown, the processor 14 analyzes the input signal based upon an instruction set 20. The instruction set 20, which may be embodied within any computer readable medium, includes processor executable instructions for configuring the processor 14 to perform a variety of tasks. The processor 14 may execute a variety of functions such as controlling the operation of the sensors 12, 12′, the user interfaces 16, 16′, and other vehicle components and systems (e.g. a climate control system, a navigation system, a fuel system, an entertainment system, a steering system, etc.) for example.

In certain embodiments, various algorithms and software can be used to analyze the input signals to determine a displacement or relative change in an X direction (delta (X_{TR})) and a Y direction (delta (Y_{TR})) of the tracking region with respect to an initial position (X_{TR-0}, Y_{TR-0}) thereof. The initial position (X_{TR-0}, Y_{TR-0}) of the tracking region is determined upon activation of the interface system 6. It is understood that the various algorithms and software can also be used to analyze the delta (X_{TR}) and the delta (Y_{TR}) of the tracking region with respect to the initial position (X_{TR-0}, Y_{TR-0}) to determine a displacement or relative change in an X direction (delta (X_{VI})) and a Y direction (delta (Y_{VI})) of the visual indicator 19 with respect to an initial position (X_{VI-0}, Y_{VI-0}) thereof. The initial position (X_{VI-0}, Y_{VI-0}) of the visual indicator 19 can be controlled by pre-defined settings of the processor 14 and instruction set 20. For example, the initial position (X_{VI-0}, Y_{VI-0}) of the visual indicator 19 can be a predetermined location on at least one the displays 26, 26′ of the respective user interfaces 16, 16′ such as a center location, an upper left hand corner, an upper right hand corner, a lower left hand corner, a lower right hand corner, or any location therebetween, for example.

The various algorithms and software may also be used to analyze the delta (X_{TR}) and the delta (Y_{TR}) of the tracking region with respect to the initial position (X_{TR-0}, Y_{TR-0}) thereof to determine a pointing vector 21 and/or a field of pointing 22 if desired. The pointing vector 21 represents at least a pointing direction of the tracking region and the field of pointing 22 is defined by a pre-determined range of degrees (e.g. +/−five degrees) diverging from the pointing vector 21. It is understood that any range of degrees relative to the calculated pointing vector 21 can be used to define the field of pointing 22.

As a non-limiting example, the instruction set 20 is a learning algorithm adapted to determine the delta (X_{TR}) and the delta (Y_{TR}) of the tracking region with respect to the initial position (X_{TR-0}, Y_{TR-0}) thereof based upon the information received by the processor 14 (e.g. via the sensor signal). As another non-limiting example, the instruction set 20 is a learning algorithm adapted to determine the delta (X_{VI}) and the delta (Y_{VI}) of the visual indicator 19 with respect to an initial position (X_{VI-0}, Y_{VI-0}) thereof based upon the delta (X_{TR}) and the delta (Y_{TR}) of the tracking region with respect to the initial position (X_{TR-0}, Y_{TR-0}) thereof. The initial position of the visual indicator 19 (X_{VI-0}, Y_{VI-0}) can be controlled by pre-defined settings of the processor 14 and the instruction set 20.

The instruction set 20 is further adapted to control attributes (i.e. a speed at which the cursor moves and the sensitivity of the cursor to the movement of the tracking region of the user) and parameters (e.g. an amplification factor also referred to as “gain”) of the visual indicator 19. It is understood that the attributes and the parameters of the visual indicator 19 can be controlled by pre-defined settings of the processor 14 and the instruction set 20. For example, when the gain parameter setting of the visual indicator 19 is four (4), each of the delta (X_{TR}) and the delta (Y_{TR}) of the tracking region with respect to the initial position (X_{TR-0}, Y_{TR-0}) thereof is multiplied by a factor of four (4) to determine the delta (X_{VI}) and the delta (Y_{VI}) of the visual indicator 19 with respect to the initial position (X_{VI-0}, Y_{VI-0}) thereof.

In certain embodiments, the processor 14 includes a storage device 23. The storage device 23 may be a single storage device or may be multiple storage devices. Furthermore, the storage device 23 may be a solid state storage system, a magnetic storage system, an optical storage system, or any other suitable storage system or device. It is understood that the storage device 23 may be adapted to store the instruction set 20. Other data and information may be stored and cataloged in the storage device 23 such as the data collected by the sensors 12, 12′ and the user interfaces 16, 16′, the calculated pointing vector 21, and the field of pointing 22, for example. In certain embodiments, the initial position (X_{TR-0}, Y_{TR-0}) of the tracking region of the user can be calculated and stored on the storage device 23 for subsequent retrieval.

The processor 14 may further include a programmable component 25. It is understood that the programmable component 25 may be in communication with any other component of the interface system 6 such as the sensors 12, 12′ and the user interfaces 16, 16′, for example. In certain embodiments, the programmable component 25 is adapted to manage and control processing functions of the processor 14. Specifically, the programmable component 25 is adapted to modify the instruction set 20 and control the analysis of the signals and information received by the processor 14. It is understood that the programmable component 25 may be adapted to manage and control the sensors 12, 12′, the user interfaces 16, 16′, and the control attributes and the parameters of the visual indicator 19. It is further understood that the programmable component 25 may be adapted to store data and information on the storage device 23, and retrieve data and information from the storage device 23.

The user interfaces 16, 16′ can include any device or component (e.g. buttons, touch screens, knobs, and the like) to control a function associated with the vehicle 8. It is understood that the user interfaces 16, 16′ can be defined as a single device such as a button or control apparatus, for example. It is further understood that the user interfaces 16, 16′ can be employed in various locations throughout the vehicle 8.

As shown, each of the user interfaces 16, 16′ includes the display 26, 26′, respectively, for generating a visible output to the user. It is understood that any type of display can be used such as a two dimensional display, a three dimensional display, a touch screen, and the like. In the embodiment shown in FIGS. 1 and 3-5, the display 26 is a heads-up display and the display 26′ is a center stack display. It is understood, however, that the displays 26, 26′ can be disposed in various locations throughout the vehicle 8 such as a headrest, an overhead module, and the like, for example. As a non-limiting example, the visual output generated by the displays 26, 26′ is a menu system including a plurality of controls 28, 28′, respectively. Each of the controls 28, 28′ is associated with an executable function of a vehicle system 30 such as the climate control system, the navigation system, the entertainment system, a communication device adapted to connect to the Internet, and the like, for example. However, any vehicle system can be associated with the controls 28, 28′. It is further understood that any number of other controls 32 can be integrated with the displays 26, 26′ or disposed in various locations throughout the vehicle 8 (e.g. on a steering wheel, dash board, console, or center stack), for example.

To use, the interface system 6 is first activated by the user input 10. As a non-limiting example, the processor 14 determines activation of the interface system 6 by the user input 10 based upon the instruction set 20. Once the interface system 6 is activated, an image of the tracking region of the user is captured by at least one of the sensors 12, 12′. The processor 14 receives the input signal (i.e. the sensor signal) and information relating to the captured image from the at least one of the sensors 12, 12′. The processor 14 analyzes the input signal and the information based upon the instruction set 20 to determine the initial position (X_{TR-0}, Y_{TR-0}) of the tracking region. The initial position (X_{TR-0}, Y_{TR-0}) of the tracking region is then stored in the storage device.

Thereafter, the sensors 12, 12′ continue capturing the time-sequenced images of the tracking region and generating input signals (i.e. the sensor signals) representing the captured images. The processor 14 continuously receives the input signals and information relating to the captured images from the sensors 12, 12′. The processor 14 analyzes the input signals and the information based upon the instruction set 20 to determine the delta (X_{TR}) and the delta (Y_{TR}) of the tracking region with respect to the initial position (X_{TR-0}, Y_{TR-0}) thereof. The processor 14 then analyzes the delta (X_{TR}) and the delta (Y_{TR}) of the tracking region with respect to the initial position (X_{TR-0}, Y_{TR-0}) to determine the delta (X_{VI}) and the delta (Y_{VI}) of the visual indicator 19 with respect to an initial position (X_{VI-0}, Y_{VI-0}) thereof.

The processor 14 then transmits at least one control signal to the respective display 26, 26′ to control the visual indicator 19 presented on the respective display 26, 26′ (e.g. a position of the cursor, a position of the highlight, or a color, a position, and/or a size of the controls 28, 28′) based upon the delta (X_{VI}) and the delta (Y_{VI}) of the visual indicator 19 with respect to an initial position (X_{VI-0}, Y_{VI-0}) thereof. Accordingly, as the tracking region of the user is moved in a desired direction (i.e. left, right, up, down, etc.), the visual indicator 19 presented on the respective display 26, 26′ substantially simultaneously moves in the desired direction.

In certain embodiments, the processor 14 continuously analyzes the position of the visual indicator 19 and determines whether the visual indicator 19 is within a predetermined region of one of the controls 28, 28′. As a non-limiting example, the processor 14 determines whether the visual indicator 19 is within the predetermined region of one of the controls 28, 28′ based upon the instruction set 20. In certain embodiments, when the visual indicator 19 is within the predetermined region of one of the controls 28, 28′, the processor 14 controls the respective display 26, 26′ to provide notification to the user that one of the controls 28, 28′ is selected. It is understood that notification can be by any means as desired such as a visual notification (e.g. illuminating with a greater intensity or enlarging the selected control 28, 28′ relative to an illumination and size of the non-selected controls 28, 28′), an audible notification (e.g. noise alert), or a haptic notification (e.g. vibration), for example.

The processor 14 then determines whether a trigger mechanism 34 (shown in FIG. 2) is activated by the user while the one of the controls 28, 28′ is selected. In a non-limiting example, the processor 14 determines activation of the trigger mechanism 34 based upon the instruction set 20. It is understood that trigger mechanism 34 can be any trigger mechanism activated by any means such as a spatial command (e.g. an eye, a head, or hand movement), an audible command (e.g. a voice instruction), and a haptic command (e.g. a push button, a switch, a slide, etc.), for example. In certain embodiments, the trigger mechanism 34 is activated by the user input 10 so that the selected control 28, 28′ can be “engaged” and the interface system 6 can be deactivated substantially simultaneously by a single activation of the user input 10 by the user. In certain other embodiments, the trigger mechanism 34 is activated by one of the controls 32 integrated with the displays 26, 26′ or disposed in various locations throughout the vehicle 8. Activation of the trigger mechanism 34 “engages” the selected control 28, 28′ and the executable function of a vehicle system 30 is performed.

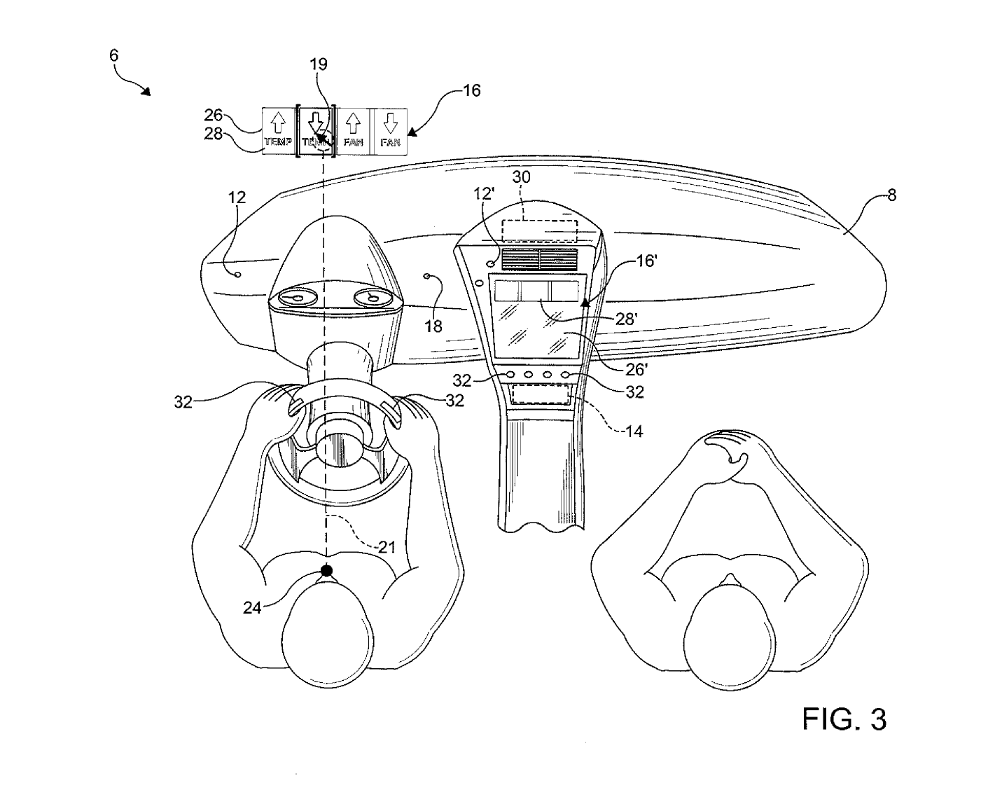

As shown in FIGS. 3-5, the processor 14 may also analyze the delta (X_{TR}) and the delta (Y_{TR}) of the tracking region with respect to the initial position (X_{TR-0}, Y_{TR-0}) thereof based upon the instruction set 20 to determine the pointing vector 21 and/or the field of pointing 22. The relative position of the tracking portion of the user can then be stored as a vector node 24. It is also understood that multiple vector nodes 24 can be generated by the processor 14 based upon the analysis of the input signals. Once the pointing vector 21 is generated, the processor 14 simulates an extension of the pointing vector 21 toward the user interface 16. The portion of the user interface 16 intersected by the pointing vector 21 represents a center of the field of pointing 22. A tolerance range around the center point of the field of pointing 22 can be controlled by pre-defined settings of the processor 14 and instruction set 20.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An adaptive interface system comprising:
a user interface for controlling a vehicle system;
a sensor for detecting a tracking region of a user and generating a sensor signal representing the tracking region of the user; and
a processor in communication with the sensor and the user interface, wherein the processor receives the sensor signal, analyzes the sensor signal based upon an instruction set to determine a displacement of the tracking region, and controls a visual indicator presented on the user interface based upon the displacement of the tracking region.

2. The interface system according to claim 1, wherein the tracking region is at least one of at least a portion of a head of the user and at least a portion of an object associated with the head of the user.

3. The interface system according to claim 1, wherein the instruction set is an algorithm for determining the displacement of the tracking region of the user.

4. The interface system according to claim 1, wherein the displacement of the tracking region is determined from a relative change in an X position and a Y position of the tracking region with respect to an initial position thereof.

5. The interface system according to claim 4, wherein the initial position of the tracking region is determined upon an activation of the interface system.

6. The interface system according to claim 1, wherein the instruction set is an algorithm for determining a displacement of the visual indicator based upon the displacement of the tracking region of the user.

7. The interface system according to claim 6, wherein the displacement of the visual indicator is determined to be a relative change in an X position and a Y position of the visual indicator with respect to an initial position thereof.

8. The interface system according to claim 7, wherein the initial position of the visual indicator is controlled by pre-defined settings of the processor and the instruction set.

9. The interface system according to claim 1, wherein the sensor is a tracking device for capturing an image of the tracking region of the user.

10. The interface system according to claim 1, further comprising a source of electromagnetic radiation to illuminate the tracking portion of the user to facilitate the detecting of the tracking portion of the user.

11. An adaptive interface system for a vehicle comprising:
at least one user interface including a display, the display having a control for a vehicle system;
a sensor for detecting a tracking region of a user by capturing an image of the tracking region of the user, wherein the sensor generates a sensor signal representing the captured image of the tracking region of the user; and
a processor in communication with the sensor, the vehicle system, and the one user interface, wherein the processor receives the sensor signal, analyzes the sensor signal based upon an instruction set to determine a displacement of the tracking region of the user, and controls a visual indicator presented on the display based upon the displacement of the tracking region, and wherein the visual indicator selects the control for the vehicle system.

12. The interface system according to claim 11, wherein the instruction set is an algorithm for determining the displacement of the tracking region based upon the captured image.

13. The interface system according to claim 11, wherein the displacement of the tracking region is determined from a relative change in an X position and a Y position of the tracking region with respect to an initial position thereof.

14. The interface system according to claim 11, wherein the instruction set is an algorithm for determining a displacement of the visual indicator based upon the displacement of the tracking region of the user.

15. The interface system according to claim 14, wherein the displacement of the visual indicator is determined to be a relative change in an X position and a Y position of the visual indicator with respect to an initial position thereof.

16. The interface system according to claim 11, wherein the control selected by the visual indicator is engaged by a trigger mechanism.

17. The interface system according to claim 16, wherein the trigger mechanism is a user input for activating and deactivating the interface system.

18. A method for configuring a display, the method comprising the steps of:
providing a user interface for controlling a vehicle system;
providing a sensor to detect a tracking region of a user;
determining a displacement of the tracking region of the user; and
controlling a visual indicator presented on the user interface based upon the displacement of the tracking region of the user.

19. The method according to claim 18, wherein the sensor captures an image of the tracking region of the user, and the displacement of the tracking region is based upon the captured image.

20. The method according to claim 18, wherein the visual indicator selects a control of at least one vehicle system, the selected control engageable by a trigger mechanism.
